(19) United States
(12) Patent Application Publication
(10) Pub. No.: US 2008/0116082 A1
(43) Pub. Date: May 22, 2008

(54) Micro-Band Electrode Manufacturing Method

(76) Inventors: Mark Hyland, Yarnton (GB); Kevin Lorimer, Yarnton (GB); Peter James Dobson, Yarnton (GB); Herbert Frank Askew, Yarnton (GB)

Correspondence Address: Quarles & Brady, 411 E. Wisconsin Avenue, Milwaukee, WI, 53202, US

(21) Appl. No.: 11/629,389

(22) PCT Filed: Jun. 14, 2005
(86) PCT No.: PCT/GB05/02345

§ 371 Date: Dec. 17, 2007

(30) Foreign Application Priority Data
Jun. 14, 2004 (GB) 0413224.7
Jun. 14, 2004 (GB) 0413244.5

(51) Int. Cl. G01N 27/403

(52) U.S. Cl. 205/775; 29/623.1; 204/400

(57) ABSTRACT

A process for producing a device comprising an electrochemical cell, said device comprising a strip having a receptacle or partial receptacle formed therein, a working electrode of the electrochemical cell being located in a wall of the receptacle or partial receptacle, wherein the process comprises the steps of—forming a laminate comprising a working electrode layer between two insulating layers; —creating a hole or well in the laminate, the hole or well passing through the working electrode layer; and optionally—attaching the laminate to a base, to form a receptacle; wherein said step of creating a hole or well comprises laser drilling the laminate.

### FIELD OF THE INVENTION

The present invention relates to a process for manufacturing a device comprising an electrochemical cell, a device obtained or obtainable by this process, and an electrochemical sensing method employing the device.

### BACKGROUND TO THE INVENTION

Electrochemical cells containing microelectrodes, for example micro-band electrodes, are used for the electrochemical detection of various parameters of a substance. For example, such a cell may be used to detect, or measure the concentration of, a particular compound in a test substance. The use of electrochemical cells comprising microelectrodes as sampling devices brings a number of potential benefits including speed of operation, accuracy and minimal sample requirement. By using the microelectrodes in conjunction with enzymes or other electroactive substances it is possible to create sensors that provide quantitative measurement of target parameters through reactions with the corresponding electroactive substance.

Electrochemical cells are known which are in the form of a well-like structure which incorporates the working electrode of the electrochemical cell as a micro-band electrode in its walls. Optionally one or more other electrodes may also be present in the walls of the well. An enzyme or other electroactive substance may be present in the well. The substance to be tested can be inserted into the well and, following reaction with the electroactive substance, electrochemical measurement carried out.

Such cells are typically manufactured by mechanically punching a hole through a laminate comprising a layer of working electrode material to form the walls of the well. A further insulating material is then attached to this laminate to form the well-structure. The mechanical punching step exposes the edge of the working electrode layer, thus forming a micro-band electrode in the wall of the well.

Whilst this technique is a convenient way to produce a microelectrode in the well, the punching step can cause damage to the laminate. For example, cracking of the laminate layers and de-lamination have been observed. In particular, insulating layers may become detached from the working electrode layer. Further problems are associated with the smearing of electrode layers down the walls of the well, leading to a loss of definition in the individual layers in the walls of the final well. This is a particular problem in the case of silver-based electrodes as the increased degree of silver in the walls of the well can cause denaturing of any enzymes which are inserted into the well. These problems can lead to inconsistencies in the electrochemical results measured by the cell, and in some cases, can cause contamination of the well, or electrode shorting. The use of a mechanical tool also inherently limits the size and shape of the well which is produced to those which are accessible by mechanical techniques.

A new manufacturing technique is therefore required to allow production of this type of electrochemical cell whilst reducing the problems associated with damage to the interior of the well.

### SUMMARY OF THE INVENTION

The present invention therefore provides a process for producing a device comprising an electrochemical cell, said device comprising a strip having a receptacle or partial receptacle formed therein, a working electrode of the electrochemical cell being located in a wall of the receptacle or partial receptacle,

wherein the process comprises the steps of

forming a laminate comprising a working electrode layer between two insulating layers;

creating a hole or well in the laminate, the hole or well passing through the working electrode layer; and optionally

attaching the laminate to a base, to form a receptacle;

wherein said step of creating a hole or well comprises laser drilling the laminate.

These steps may be carried out in any order, for example the order stated above.

The present inventors have surprisingly found that laser drilling the hole or well in the laminate leads to a device in which the surface of the walls of the receptacle or partial receptacle is significantly improved compared with the surface of a device produced using a mechanical punching or drilling step. The appearance of the surface of the walls appears to be different. The laser drilling method also results in a lower degree of damage to the surface of the walls, and to the laminate structure itself. In particular, cracking and de-lamination may be reduced.

The differences in the surface of the walls is apparent from the improved electrochemical results obtained when using an electrochemical cell produced in this manner. In particular, the results of tests are typically more reliable, such that less variation is seen between repetitions of the same experiment. Furthermore, peak definition can be improved, in particular when detecting substances such as cobalt that are detectable only when adsorbed onto the working electrode.

The laser drilling technique also expands the range of possible sizes and shapes of holes that can be produced. This introduces the possibility of further miniaturisation of the receptacles or partial receptacles.

Laser drilling also introduces the possibility of creating a well in the strip, rather than a hole which passes completely through the strip. The creation of a well has the advantage that a receptacle is directly formed in the laminate. The step of attaching a separate base is therefore not necessary.

In one embodiment of the invention, a hole having sloping walls, for example shaped substantially in the form of a truncated cone is produced. In this embodiment, if the hole is sufficiently small at its narrowest end (typically no more than about 600 μm), a liquid substrate will not be able to leave through the narrow end of the hole due to surface tension. Thus, in this embodiment, it is not necessary to attach a separate base to the laminate as the laminate, alone, forms a receptacle.

Furthermore, the truncated cone-shaped hole provides not only an opening through which a sample can enter, but also a vent hole through which displaced air can leave. Previous devices have been produced using a separate step of creating a vent hole in the receptacle or partial receptacle to allow escape of displaced air as a liquid sample enters the receptacle. In this embodiment of the invention, the separate formation of a vent hole is not required. This is particularly advantageous since the separate formation of a vent hole introduces difficulties in lining up the vent hole correctly with the receptacle.

In an alternative embodiment, the invention also provides a process in which the step of creating a hole or well comprises cutting the laminate by water-jet or ultra-sonic cutting. Such a technique may also provide an improved surface of the walls of the receptacle compared with mechanical punching or drilling and may reduce damage (e.g. cracking and de-lamination) to the wall surface. This in turn may lead to improved electrochemical response in an electrochemical cell produced in this manner.

The present invention also provides a device obtained or obtainable by a process according to the invention. Also provided is an electrochemical sensing method comprising

inserting a sample into the receptacle or partial receptacle of a device obtained or obtainable by a process according to the invention;

applying a potential across the electrochemical cell; and

measuring the resulting electrochemical response.

### BRIEF DESCRIPTION OF THE FIGURES

FIG. 1 depicts a device produced according to one embodiment of the invention;

FIG. 2 depicts a device produced according to an alternative embodiment of the invention;

FIG. 3 depicts a device produced according to a further embodiment of the invention; and

FIGS. 4 and 5 depict the results of electrochemical measurements carried out on devices of the invention, as well as devices produced by known techniques.

FIG. 6 depicts the variation in results (% CV) of electrochemical measurements carried out on devices produced using a variety of laser operating conditions.

### DETAILED DESCRIPTION OF THE INVENTION

An electrochemical cell comprises at least two electrodes. When in use, electrochemical reactions occurring at each of the electrodes cause electrons to flow to and from the electrodes, thus generating a current. An electrochemical cell can be set-up either to harness the electrical current produced, for example in the form of a battery, or to detect electrochemical reactions which are induced by an applied current or voltage.

As used herein, a microelectrode is an electrode having at least one dimension not exceeding 50 μm. A microelectrode may have a dimension which is macro in size, i.e. which is greater than 50 μm. A micro-band electrode has one dimension not exceeding 50 μm and one dimension substantially larger than 50 μm such that the surface of the electrode forms a thin strip or band.

As used herein, a receptacle is a component, for example a container, which is capable of containing a liquid placed into it. A partial receptacle is a component which forms a receptacle when placed onto a substrate. Thus, a partial receptacle when placed on a substrate is capable of containing a liquid.

An electrochemical cell may be either a two-electrode or a three-electrode system. A two-electrode system comprises a working electrode and a pseudo-reference electrode. A three-electrode system comprises a working electrode, a pseudo reference electrode and a separate counter electrode. As used herein, a pseudo reference electrode is an electrode that is capable of providing a reference potential. In a two-electrode system, the pseudo reference electrode also acts as the counter electrode and is thus able to pass a current without substantially perturbing the reference potential. In a three-electrode system the pseudo reference electrode typically acts as a true reference electrode and is, for example, a standard hydrogen or calomel electrode.

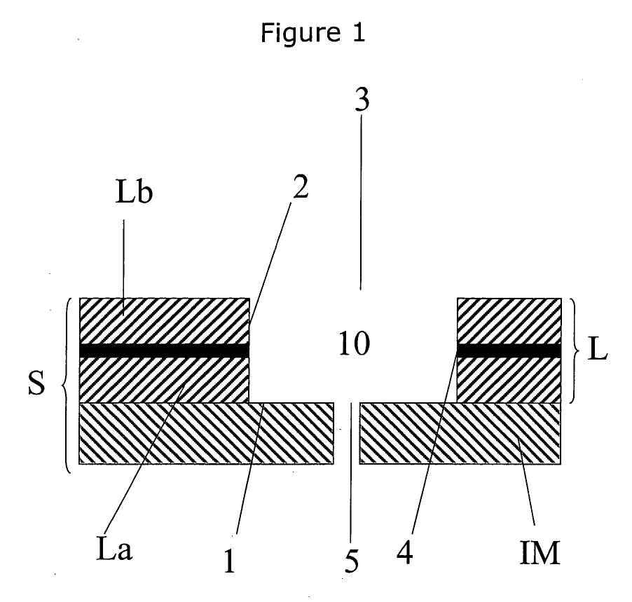

In one embodiment of the invention, the process provides a device as depicted in FIG. 1. The device comprises a strip S having a receptacle 10 formed therein. The strip S may have any shape or size. The receptacle in this embodiment has a base 1, walls 2 and a first open part 3. It is noted, however, that the present invention encompasses devices in which the receptacle has a different shape, for example it may be a cone, truncated cone or a channel. The device comprises an electrochemical cell and the working electrode 4 of the electrochemical cell is located in the wall 2 of the receptacle. The device also comprises a pseudo reference electrode, which may be in any desired location. The pseudo reference electrode is not depicted in FIG. 1. A separate counter electrode may also be provided.

The process of the invention comprises producing such a device by first forming a laminate L comprising a working electrode layer between two insulating layers La, Lb. Additional layers may be included in the laminate if desired. The laminate may be formed, for example, by printing a working electrode layer onto layer La or Lb, typically onto layer La.

The working electrode is preferably formed from carbon, palladium, gold, platinum, copper or silver, e.g. carbon, palladium, gold or platinum, in particular carbon, for example in the form of a conductive ink. The conductive ink may be a modified ink containing additional materials, for example platinum and/or graphite.

The ink is typically printed onto the insulating material La, Lb using a screen printing, ink jet printing, thermal transfer or lithographic or gravure printing technique, for example the techniques described in WO 02/076160 (the contents of which are incorporated herein in their entirety by reference). Two or more coatings which are formed of the same or different materials, may be applied, if desired. The thickness of the working electrode layer is typically from 0.01 to 25 μm, preferably from 0.05 to 15 μm, for example 0.1 to 20 μm, more preferably from 0.1 to 10 μm. Thicker working electrode layers are also envisaged, for example thicknesses of from 0.1 to 50 μm, preferably from 5 to 20 μm.

Printing of the working electrode onto the layer La or Lb is typically carried out in a chosen pattern. The pattern selected is one that ensures that at least a part of the working electrode layer is exposed when the hole or well is created. Electrically conducting tracks are also conveniently printed onto the insulating layer La or Lb. The electrical tracks connect the working electrode to any required instruments such as a potentiostat. The tracks may be made of any suitable conducting material, such as the material used for the working electrode itself.

The second insulating layer, typically layer Lb, may be formed by printing an insulating material onto the working electrode layer. Other techniques for forming the insulating layer include solvent evaporation of a solution of the insulating material or formation of an insulating polymer by a cross-linking mechanism. Alternatively, the insulating layer may be formed by laminating, for example thermally laminating, a layer of insulating material to the working electrode layer.

The insulating layers La, Lb are typically formed of a polymer, for example, an acrylate, polyurethane, PET, polyolefin, polyester, PVC or any other stable insulating material. In one embodiment the polymer is an acrylate, polyurethane, PET, polyolefin or polyester. Polycarbonate and other plastics and ceramics are also suitable insulating materials.

In the embodiment depicted in FIG. 1, the thus formed laminate L typically has a depth (i.e. the distance across the layers of the laminate from the surface of layer La to the surface of layer Lb, and the length through which the hole is created) of from 50 to 1000 μm, preferably from 200 to 800 μm, for example from 300 to 600 μm.

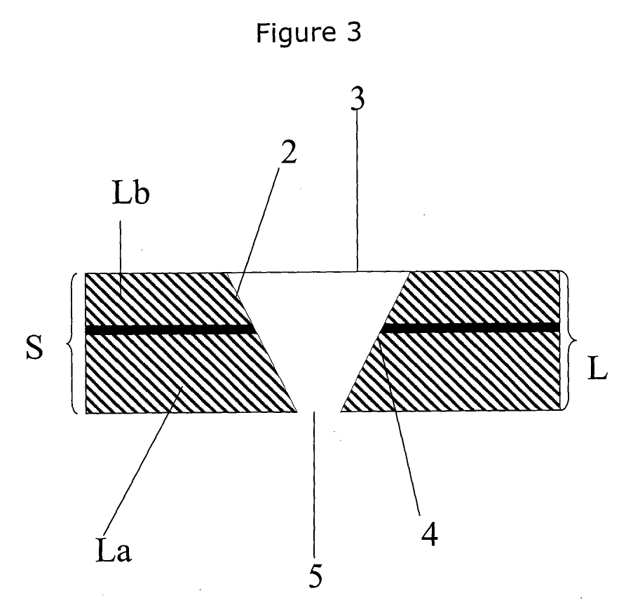

A hole or well is then created in the laminate L. A hole passes completely through the laminate. In order to form a receptacle it is therefore typically necessary to attach a further substrate to the laminate, although the separate attachment of a further substrate can be avoided in some embodiments as described below with reference to FIG. 3. In contrast, a well does not completely pass through the laminate, but rather forms an indentation or well in the laminate such that a receptacle is directly formed in the laminate without the addition of a separate substrate. In either case, the hole or well should completely pass through the working electrode layer such that the edge of the working electrode layer is exposed. In the embodiment depicted in FIG. 1, a hole is created through the laminate.

The creation of the hole or well comprises a laser drilling step. Laser drilling may be used alone, such that the laser-drilling step creates the hole or well in the laminate. Alternatively, laser drilling and another technique, for example a mechanical technique, may be used in combination. For example, laser drilling may be used to create the edges of the hole or well by laser drilling a ring in the laminate to create a substantially annular hole or well surrounding a central plug (i.e. by a trepanning method). The central plug may be removed separately. A mechanical punching step may be used to remove the central plug. In this embodiment, the laser drilling step is used to form the edges of the hole or well, i.e. the part which will form the walls of the receptacle or partial receptacle. In a preferred aspect of this embodiment, the laser drilling step only penetrates a part of the laminate (i.e. an annular well is formed), and a mechanical punching step is used to cut through the remainder of the laminate. The laser drilling step typically penetrates at least the upper insulating layer Lb and the working electrode layer.

Alternatively, a hole or well could be mechanically punched and the edges of the hole or well enlarged by laser-drilling. The laser-drilling step could, for example, remove only a small amount of material, such that the laser-drilling step effectively cleans the surfaces of the walls of the hole or well. In this embodiment, the laser-drilling step is used to form the edges of the hole or well, i.e. the part which will form the walls of the receptacle or partial receptacle.

Where a trepanning technique is used to create the hole or well, the trepan speed (T) and the pulse rate frequency (prf) of the laser preferably satisfy the relationship T (rpm)/prf (kHz)>200, preferably T (rpm)/prf (kHz)>250. When this relationship is met, it has been found that the resulting electrochemical cell provides more accurate and consistent results. Whilst not wishing to be bound by any particular theory, it is thought that this improved result is due to a reduction in heat induced damage in the sample due to the decrease in overlap of the beam pluses. Those skilled in the art will therefore appreciate that such heating effects can be controlled by judicious choice of laser parameters and the relationship between T and prf is simply an example of how this beneficial effect may be achieved.

Laser drilling may be carried out using any appropriate laser drilling equipment. Lasers operating in the UV (for example from 50 to 400 nm), visible (for example from 400 to 700 nm) or IR (for example from 700 nm to 10 μm, in particular the near infrared region of from 700 nm to 5 μm) wavelengths may be used. Suitable wavelengths include, for example, from 100 to 400 nm e.g. from 150 to 400 nm. Pulsed or continuous wave lasers may be used. Where a pulsed laser is employed, a preferred pulse width is from 0.1 ps to 1000 ns. For example the pulse width may be from 0.1 ps to 1000 ps. Alternatively, the pulse width may be from 0.1 ns to 1000 ns, e.g. from ins to 100 ns. Electrochemical cells produced using lasers employing this pulse width have been found to be more accurate, producing results having a low coefficient of variation.

In one embodiment of the invention, the hole or well is created using a water-jet guided laser, e.g. the laser-microjet technique by Synova.

Examples of suitable lasers include excimer, nitrogen, helium cadmium and ion lasers, each of which operate in the UV and/or visible range. Helium neon and CO₂ lasers, which operate in the IR and/or visible regions can also be used. Alternative lasers include diode lasers and solid state lasers, for example YAG lasers and Vanadate lasers. Preferred examples of lasers include excimer lasers, Vanadate lasers and YAG lasers, e.g. multiple (including double, triple and quadruple) frequency Vanadate or YAG lasers.

In one embodiment of the invention, one or both of insulating layers La, Lb, typically at least layer La, comprises a dye. The dye is typically selected to increase absorption of the insulating layers in the wavelength of operation of the laser. Thus, for example, for a laser operating in the UV spectrum, a dye which absorbs UV light could be incorporated into layers La and/or Lb. In this embodiment, absorbance of the laminate L in the laser wavelength is greatly enhanced, which improves the ease and rate of laser drilling. For example, the absorbance of laminate L in the laser wavelength may be over 50%, 75%, 90% or 95%. Appropriate dyes which absorb in the desired wavelengths would be known to those skilled in the art.

In a further embodiment of the invention, laser drilling is carried out in the presence of an assist gas. The use of an assist gas aids removal of molten material in the laser cut and thereby increases the rate of drilling. Both reactive assist gases, e.g. oxygen, and non-reactive assist gases, e.g. inert gases such as argon, may be employed.

In a particular aspect of this embodiment, oxygen is used as an assist gas. In this aspect, the surface cut by the laser may be oxidised. Oxidation of the working electrode surface is particularly advantageous as this enables functionality to be introduced at the working electrode. This technique may be employed, for example, in binding catalysts or other electroactive materials to the working electrode.

In an alternative embodiment of the invention, the creation of the hole or well comprises a water-jet or ultra-sonic cutting step. Water-jet or ultra-sonic cutting may be used alone or in combination with another technique, e.g. in combination with a mechanical technique as described above with regard to the laser drilling step. Any water-jet or ultra-sonic cutting devices known in the art and suitable for producing holes or wells of μm or nm dimensions may be employed.

Typically, the hole or well has a width of from 0.1 to 5 mm, for example 0.5 to 2.0 mm, or up to 1.5 mm, such as 1 mm. The width is defined as the maximum distance from wall to wall measured across the mid-point of the cross-section of the receptacle. In the case of a cylindrical receptacle, the width is the cross-sectional diameter.

The hole or well may be created in any desired shape. Examples of suitable shapes include cylindrical holes or wells and holes or wells having sloping walls such that the resulting receptacle or partial receptacle is in the shape of a cone or truncated cone. In the case of a cone or truncated cone-shaped well or hole, the above-mentioned widths are the typical widths of the first open part of the receptacle or partial receptacle thus formed. Alternatively, the hole or well may provide a receptacle in the form of a channel. For example, a channel may have a width of from about 100 to about 400 μm and a length of from 1 to 10 mm, for example 2 to 5 mm.

Creation of the hole or well exposes the working electrode. Preferably, the hole or well is created in such a position that the working electrode layer is exposed around the whole perimeter of the hole or well. In this case, the working electrode in the final device is in the form of a continuous band around the wall of the receptacle or partial receptacle. In a preferred embodiment, the working electrode exposed by the creation of the hole or well is a microelectrode. In a further preferred embodiment, the working electrode is a micro-band electrode.

In the embodiment depicted in FIG. 1, once the hole has been created, a base, e.g. an insulating material IM, is attached to the laminate L to form the base 1 of the receptacle. The insulating material IM comprises, for example, a polymeric sheet. Appropriate polymers are those described with reference to the insulating layers of the laminate L. The base or insulating material IM is optionally surface treated in order to provide particular properties to the surface which forms the base of the receptacle, e.g. a hydrophobic or hydrophilic surface treatment may be used. Alternatively, the insulating material IM may itself be formed from a hydrophilic or hydrophobic porous membrane. Versapor membranes from Pall filtration are examples of appropriate insulating materials.

Bonding of the base to the laminate may be carried out by any suitable technique.

For example, bonding may be performed using pressurized rollers. A heat sensitive adhesive may be used, in which case an elevated temperature is needed. Room temperature can be used for pressure sensitive adhesive.

Attachment of the base creates a receptacle in the strip S. The receptacle thus formed typically has a volume of from 0.1 to 5 μl, for example from 0.1 to 3 μl or from 0.2 to 1 μl.

In one embodiment of the invention, an electroactive substance is inserted into the thus formed receptacle. An electroactive substance is any substance which is capable of causing an electrochemical reaction when it comes into contact with a sample. Thus, on insertion of the sample into the cell and contact of the sample with the electroactive substance, electrochemical reaction may occur and a measurable current, voltage or charge may occur in the cell. The electroactive substance may, for example, comprise an electrocatalyst and/or a mediator. Suitable electrocatalysts are well known to those of skill in the art and include various metal ions (e.g. cobalt), and various enzymes (e.g. lactate oxidase, cholesterol dehydrogenase, glycerol dehydrogenase, lactate dehydrogenase, glycerol kinase, glycerol-III-phosphate oxidase and cholesterol oxidase). Examples of suitable mediators are ferricyanide/ferrocyanide and ruthenium compounds such as ruthenium (III) hexamine salts (e.g. the chloride salt).

The electroactive substance is inserted into the receptacle, for example, using micropipetting or enzyme jet printing. Micropipetting is, in one embodiment, carried out using Allegro Technologies Ltd's Spot-On™ technology or a similar technique. The electroactive substance may then be dried by any suitable technique, for example air drying, freeze drying or oven baking.

In a preferred embodiment, one or more vent holes are created in the well. These vent holes enable displaced air to escape from the receptacle when a sample enters the receptacle. Typically, a single vent hole 5 is created in the base of the receptacle, although any number of (e.g. up to 4) holes may be present if desired. The vent holes may be located other than in the base of the receptacle if desired. The vent hole may be produced by any technique, including mechanical drilling or punching, or laser drilling. The vent holes typically have capillary dimensions, for example, they may have an approximate diameter of 1-600 μm, for example from 100 to 500 μm. The vent holes should be sufficiently small that a liquid sample placed into the receptacle is substantially prevented from leaving the receptacle through the vent holes due to surface tension.

The vent hole(s) may be created either before or after attachment of the base to the laminate L. Further, the vent hole(s) may be created either before or after insertion of an electroactive substance into the receptacle. In a preferred embodiment, the electroactive substance is inserted into the receptacle and dried, and a vent hole is then created which passes through the base of the receptacle and the dried electroactive substance. In this way, the vent hole is not blocked by the electroactive substance.

If desired, a permeable or semi-permeable membrane may then be placed over the receptacle. The membrane is preferably made of a material through which the sample to be tested can pass. For example, if the sample is plasma, the membrane should be permeable to plasma. Suitable materials for use as the membrane include polyester, cellulose nitrate, polycarbonate, polysulfone, microporous polyethersulfone films, PET, cotton and nylon woven fabrics, coated glass fibres and polyacrylonitrile fabrics. These fabrics may optionally undergo a hydrophilic or hydrophobic treatment prior to use. Other surface characteristics of the membrane may also be altered if desired. For example, treatments to modify the membrane's contact angle in water may be used in order to facilitate flow of the desired sample through the membrane.

The membrane may comprise one, two or more layers of material, each of which may be the same or different, e.g. two different membranes having different functionality may be used. For example, conventional double layer membranes comprising two layers of different membrane materials may be used. In another embodiment the membrane comprises a wetting membrane and a blood filtration membrane. Petex is an appropriate wetting membrane whilst preferred filtration membranes are described below. In one embodiment the membrane comprises a petex layer and a Pall BTS layer.

The membrane may also be used to filter out some components which are not desired to enter the cell. For example, some blood products such as red blood cells or erythrocytes may be separated out in this manner such that these particles do not enter the receptacle. Suitable filtration membranes, including blood filtration membranes, are known in the art. Examples of blood filtration membranes are Presence 200 of Pall filtration, Whatman VF2, Whatman Cyclopore, Spectral NX, Spectral X and Pall BTS, e.g. Presence 200 of Pall filtration, Whatman VF2, Whatman Cyclopore, Spectral NX and Spectral X. Fibreglass filters, for example Whatman VF2, can separate plasma from whole blood and are suitable for use where a whole blood specimen is supplied to the device and the sample to be tested is plasma. An active membrane which removes LDL from the blood can also be used.

The membrane is typically attached to the surface of the strip using, for example, double sided adhesive or screen printed pressure sensitive adhesive. Attachment of the membrane may, for example, be carried out by using a pressure sensitive adhesive (which has been cast) that has been die cut to remove the adhesive in the area over the receptacle, and typically over a wider working area.

In an alternative embodiment of the invention, the strip S comprises a partial receptacle. In this embodiment, the partial receptacle comprises a wall or walls 2 which connect the first open part 3 with a second open part. The second open part may be placed against the substrate to form a receptacle, such that the substrate forms the true base of the receptacle thus formed. These devices can be produced in accordance with the process of the invention by creating a hole in the laminate L, but not carrying out the step of attaching a base to the laminate.

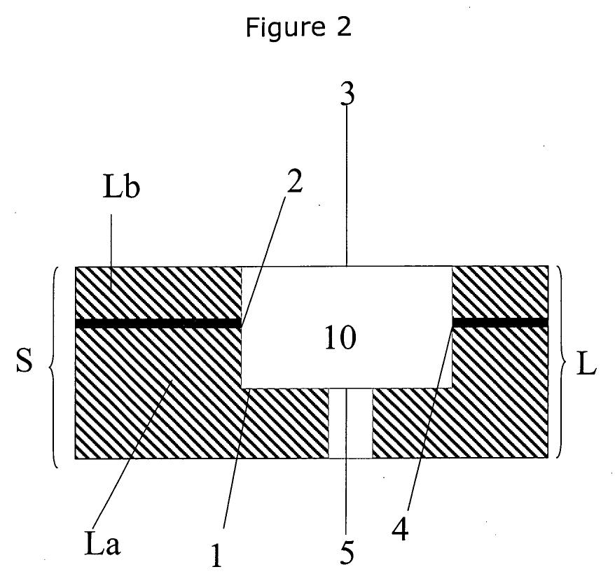

A further alternative embodiment of the invention, which is the same as the first embodiment except as described below, is depicted in FIG. 2. In this embodiment, the process comprises forming a well in the laminate L. Thus, the laser drilling step typically comprises creating a well having the dimensions and volume of the desired receptacle 10 directly in the laminate L. This therefore avoids the additional step of attaching a base to the laminate. In this case, the strip may consist only of the laminate L.

In this embodiment, the laminate L typically has a thickness of at least 1 mm, for example at least 1.5 mm or at least 2 mm. The well created in the laminate typically has a depth of from 50 to 1000 μm, preferably from 200 to 800 μm, for example from 300 to 600 μm.

A further alternative embodiment of the invention, which is the same as the first embodiment except as described below, is depicted in FIG. 3. In this embodiment, a hole having sloping walls is created in the laminate such that the narrowest part of the hole has a width of, for example, no more than 600 μm. Preferred widths of the narrowest part of the hole are from 1-600 μm, for example from 100 to 500 μm. The width at the narrowest part of the hole is defined as the distance from wall to wall measured across the mid-point of the cross-section of the hole, at its narrowest point.

Typically, in this embodiment, the hole is a truncated cone-shaped hole having a width which gradually decreases moving away from the first open part 3. The width of the hole is sufficiently narrow at the base that it acts as a vent hole 5. Thus, the additional steps of attaching a base to the laminate, as well as the step of creating a vent hole, can be avoided.

Devices in which the strip comprises two or more receptacles or partial receptacles as described above can also be produced by the process of the invention. This is achieved by printing a suitable pattern of working electrode layer onto the insulating layers La, Lb and creating two or more holes or wells in the laminate L. Preferably, each hole or well is produced as described above.

The device produced in accordance with the invention can be used in an electrochemical sensing method by inserting a sample for testing into the or each receptacle, applying a potential between working and counter electrodes and measuring the resulting electrochemical response. For example, the resulting current may be measured. In this way, the device may be used for determining the content of various substances in water, beer, wine, blood or urine samples, or samples of other biological or non-biological fluids. The device may, for example, be used to determine the pentachlorophenol content of a sample for environmental assessment; to measure cholesterol, HDL, LDL and triglyceride levels for use in analysing cardiac risk, or for measuring glucose levels, for example for use by diabetics. A further example of a suitable use for the device of the invention is as a renal monitor for measuring the condition of a patient suffering from kidney disease. In this case, the device could be used to monitor the levels of creatinine urea, potassium and sodium in the urine. The device can also be used to identify ischemic blood or plasma samples.

### EXAMPLES

In order to demonstrate the improved reliability of devices produced in accordance with the invention, the inventors have carried out tests to compare the consistency of results obtained using various different devices of the invention, and using devices produced using a mechanical punching step to create the hole in the laminate. All voltages set out below relate to a standard hydrogen electrode and use the IUPAC convention.

### Example 1

All tests were carried out using a device having 4 receptacles of the type depicted in FIG. 1.

A film of 250 μm PET was coated with heat seal. The film was then printed on the reverse side to the heat seal coating with a conductive carbon ink in a pattern that defines the working electrode and conductive tracks. This was then dried at 100° C. for 1 hour. The carbon ink print was subsequently over printed with a dielectric ink, except for the part of the tracks that were required to mate with the connector in the measuring instrument, where over printing was not carried out. The dielectric ink was then dried at 100° C. for 2 minutes. A further coat of dielectric ink was applied which was dried at 100° C. for 1 hour.

Four holes having a 1 mm diameter were then formed in the film by laser drilling, using a frequency quadrupled Nd YAG laser operating at 266 nm. The heat seal coated side of the film was then laminated to a base film of 125 μm PET under heating, thus creating four wells. During the heating step, the heat seal bonded to the base film. An Ag/AgCl pseudo reference electrode was used. A 250 μm diameter vent hole was created in the base of each well using a frequency quadrupled Nd YAG laser.

An aqueous solution of approximately 4.0 mM Ru(NH₃)₆Cl₃ was then applied to 5 devices produced as described above. A potential of −0.45V was applied to each cell simultaneously and after 1 second, the current of each cell was measured sequentially, leading to a total of 20 measurements.

The experiment was repeated using approximately 8.0 mM Ru(NH₃)₆Cl₃ solution.

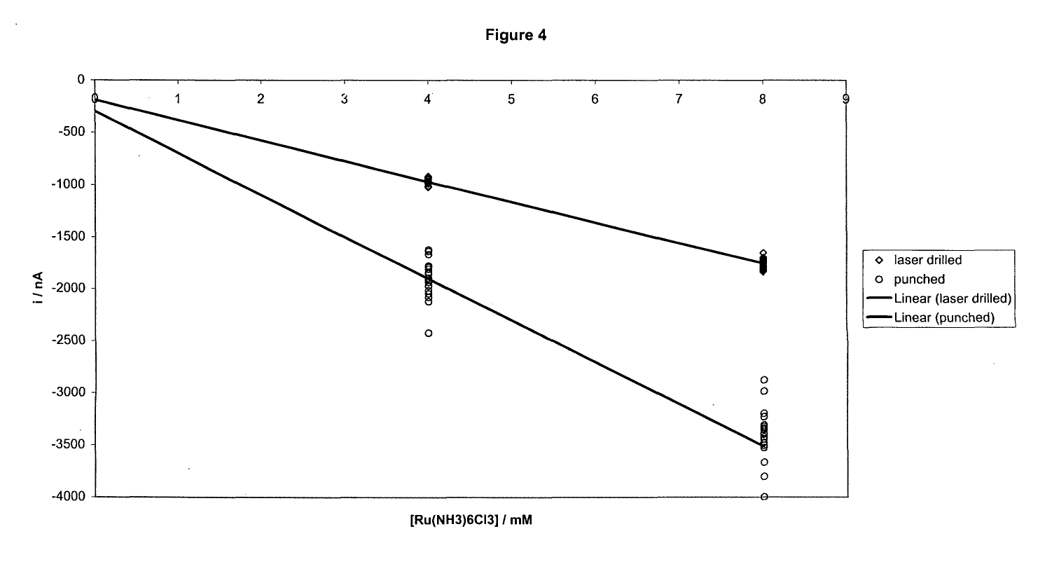

The results of both experiments are shown in FIG. 4 (points marked with squares; upper line).

### Example 2

Devices were produced in accordance with the method described in Example 1, with the exception that the holes in the film were punched using a 1 mm steel punch and die set rather than by laser drilling. Vent holes were also produced by mechanical piercing.

Aqueous solutions containing approximately 4.0 and approximately 8.0 mM Ru(NH₃)₆Cl₃ were tested using these devices in accordance with the technique described in Example 1. The results are depicted in FIG. 4 (points marked with circles; lower line).

FIG. 4 shows that a high consistency of measured current was obtained for each of the samples tested using a laser-drilled well. The distribution of measured current gave CV=3.2% at 4.0 mM and CV=2.9% at 8.0 mM (average CV=3.0%) for the laser drilled wells compared to CV=9.7% at 4.0 mM and CV=15.5% at 8.0 mM (average CV=12.6%) for the mechanically punched wells. When converted to measurements of the Ru(NH₃)₆Cl₃ concentration in mM, the laser drilled wells gave a result of CV=3.9% for 4.0 mM and CV=3.2% for 8.0 mM (average CV=3.6%) whilst the punched wells gave a result of CV=11.6% for 4.0 mM and CV=17.0% for 8.0 mM (average CV=14.3%).

### Example 3

Devices were produced in accordance with the method described in Example 1, with the exception that prior to drilling the vent holes and attaching the spreading membrane, an electroactive substance comprising cholesterol esterase and cholesterol dehydrogenase was dispensed into the wells thus formed. The substances were then freeze-dried.

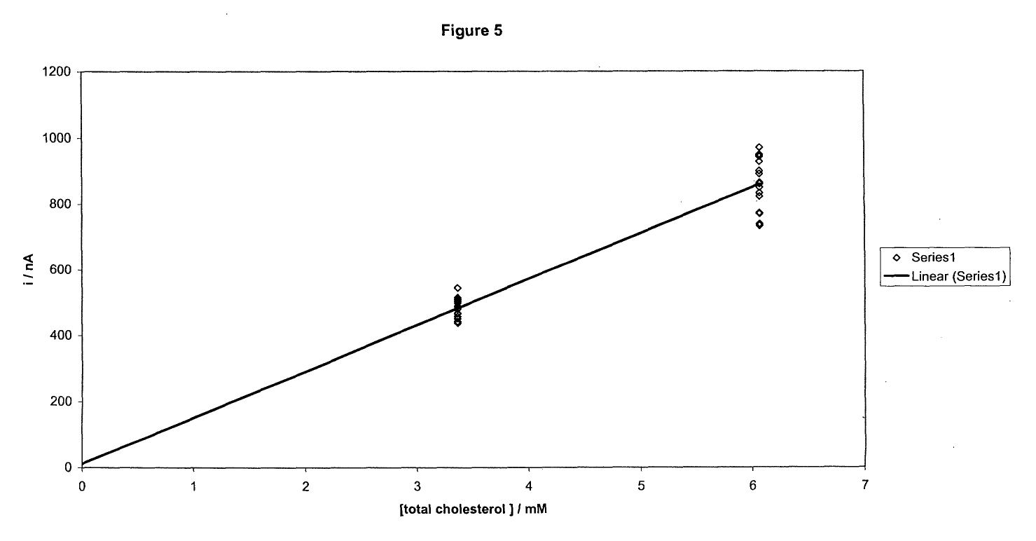

Plasma containing approximately 3.3 mM total cholesterol was then applied to 4 devices produced as described above and a 60 second wetting time allowed for the freeze-dried electroactive substance to re-suspend in the plasma. An oxidising potential of +0.15V was applied simultaneously to each cell and, after 1 second, the amperometric current was measured sequentially for each well generating a total of 16 results. The results are recorded in FIG. 5.

The experiment was repeated using plasma having a total cholesterol content of approximately 6.03 mM and these results are also recorded in FIG. 5.

FIG. 5 shows a high consistency of results was obtained. The distribution of measured current gave a CV=6.1% for the 3.3 mM total cholesterol content samples, or CV=6.2% when converted to measurements of total cholesterol concentration in mM. The distribution of measured current gave a CV=9.0% for the 6.03 mM total cholesterol content samples, or CV=9.2% when converted to measurements of total cholesterol concentration in mM. Average values were CV=7.6% (current) and CV=7.7% (concentration).

### Example 4

All tests were carried out using a device having 4 receptacles of the type depicted in FIG. 1.

A film of 250 μm PET was printed with a conductive carbon ink in a pattern that defines the working electrode and conductive tracks. This was then dried at 100° C. for 1 hour. The carbon ink print was subsequently over printed with a dielectric ink, except for the part of the tracks that were required to mate with the connector in the measuring instrument, where over printing was not carried out. The dielectric ink was then dried at 100° C. for 2 minutes. Two further coats of dielectric ink were applied and each was dried at 100° C. for 1 hour.

Four holes having a 1 mm diameter were then formed in the film by laser drilling, using a pulsed Nd:YVO₄ laser operating at a wavelength of 266 nm, a pulse rate frequency (prf) of 2 kHz and a trepan speed of 450 rpm. The film was then adhered to a base layer of Pall Versapor porous membrane using adhesive tape, thus creating four wells. An Ag/AgCl pseudo reference electrode was used.

An aqueous solution of approximately 5.0 mM Ru(NH₃)₆Cl₃ was then applied to 5 devices produced as described above. A five second period was allowed to lapse prior to application of a potential. Next, a potential of −0.45V was applied to each cell simultaneously and after 1 second, the current of each cell was measured sequentially, leading to a total of 20 measurements. The experiment was repeated using approximately 10.0 mM Ru(NH₃)₆Cl₃ solution, to provide a total of 40 measurements.

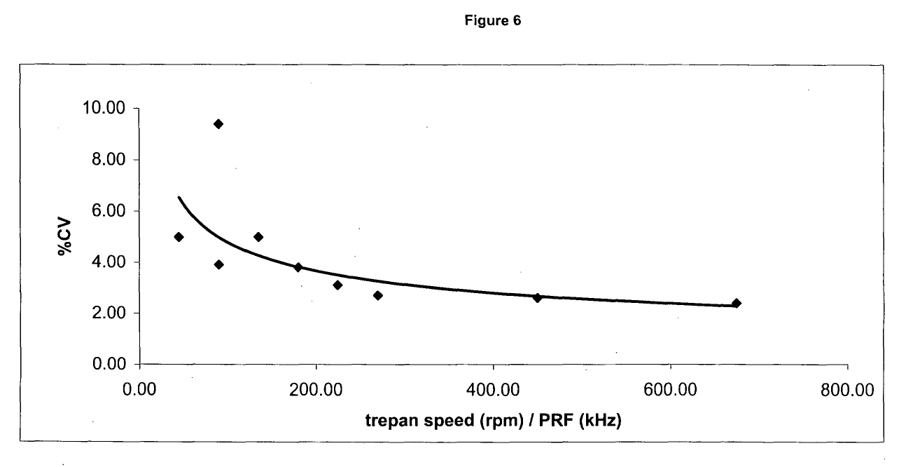

This series of experiments was repeated using devices produced using a variety of different laser operating conditions, as set out in Table 1 below. For each series of 40 results, the coefficient of variation (CV) was determined. FIG. 6 plots the resulting CV values against the ratio of trepan speed/prf.

FIG. 6 demonstrates the higher consistency of results obtained when the ratio of trepan speed (rpm)/prf (kHz) is greater than 200, in particular greater than 250.

TABLE 1

| | No. | Trepan speed | | | |
|---|---|---|---|---|---|
| Test | measurements | (T/rpm) | prf/kHz | T/prf | % CV |
| 1 | 40 | 450 | 2 | 225 | 3.10 |
| 2 | 40 | 900 | 5 | 180 | 3.80 |
| 3 | 40 | 1350 | 10 | 135 | 5.00 |
| 4 | 40 | 900 | 2 | 450 | 2.60 |
| 5 | 40 | 1350 | 5 | 270 | 2.70 |
| 6 | 40 | 450 | 10 | 45 | 5.00 |
| 7 | 40 | 1350 | 2 | 675 | 2.40 |
| 8 | 40 | 450 | 5 | 90 | 3.90 |
| 9 | 40 | 900 | 10 | 90 | 9.40 |

The invention has been described above with reference to various specific embodiments. However, it is to be understood that the invention is not limited to these specific embodiments.

1. A process for producing a device comprising an electrochemical cell, said device comprising a strip having a receptacle or partial receptacle formed therein, a working electrode of the electrochemical cell being located in a wall of the receptacle or partial receptacle,
wherein the process comprises the steps of
forming a laminate comprising a working electrode layer between two insulating layers;
creating a hole or well in the laminate, the hole or well passing through the working electrode layer; and optionally
attaching the laminate to a base, to form a receptacle;
wherein said step of creating a hole or well comprises laser drilling the laminate.

2. A process according to claim 1, wherein the laser drilling step is carried out using a laser operating at a wavelength of from 150 to 400 nm.

3. A process according to claim 1 wherein the laser drilling step is carried out using a pulsed laser having a pulse width of from 0.1 to 1000 ps.

4. A process according to claim 1 wherein the laser drilling step is carried out using a pulsed laser having a pulse width of from 1 to 100 ns.

5. A process according to claim 1, wherein the laminate comprises a dye.

6. A process according to claim 1, wherein laser drilling is carried out in the presence of a reactive assist gas.

7. A process according to claim 1, wherein the trepanning speed (T) and the pulse rate frequency (prf) of the laser used in the laser drilling step satisfy the relationship T (rpm)/prf (kHz)>200.

8. A process according to claim 1, wherein the step of creating a hole in the laminate comprises laser drilling a ring in the laminate to create a substantially annular well surrounding a central plug, and subsequently removing the central plug.

9. A modification of the process of claim 1, which process is for producing a device comprising an electrochemical cell, said device comprising a strip having a receptacle or partial receptacle formed therein, a working electrode of the electrochemical cell being located in a wall of the receptacle or partial receptacle,
wherein the process comprises the steps of
forming a laminate comprising a working electrode layer between two insulating layers;
creating a hole or well in the laminate, the hole or well passing through the working electrode layer; and optionally
attaching the laminate to a base, to form a receptacle;
wherein said step of creating a hole or well comprises cutting the laminate by water-jet or ultra-sonic cutting.

10. A process according to claim 1, which further comprises inserting an electroactive substance into the receptacle or partial receptacle and optionally drying the electroactive substance.

11. A process according to claim 1, which further comprises forming one or more vent holes in the receptacle or partial receptacle.

12. A process according to claim 1, which further comprises placing a membrane, comprising one or more layers, over at least a part of an open part of the receptacle or partial receptacle, wherein the membrane optionally comprises a blood filtration membrane layer.

13. A process according to claim 1, wherein the hole or well has sloping walls, such that the resulting receptacle or partial receptacle is substantially in the shape of a cone or truncated cone.

14. A process according to claim 13, wherein a hole having sloping walls is created in the laminate such that the narrowest part of the hole has a width of no more than 600 μm.

15. A process according to claim 1, wherein the base is surface treated to provide a hydrophilic or hydrophobic surface, or wherein the base comprises a hydrophilic or hydrophobic porous membrane.

16. A process according to claim 1, wherein the working electrode layer has a thickness not exceeding 50 μm.

17. A process according to claim 1, wherein the working electrode layer comprises carbon.

18. A device obtained or obtainable by a process according to claim 1.

19. (canceled)

20. An electrochemical sensing method comprising
inserting a sample into the receptacle or partial receptacle of a device according to claim 18;
applying a potential across the electrochemical cell; and
measuring the resulting electrochemical response.
